(19) United States
(12) Patent Application Publication
(10) Pub. No.: US 2016/0161786 A1
(43) Pub. Date: Jun. 9, 2016

(54) LIQUID CRYSTAL DISPLAY PANEL AND LIQUID CRYSTAL DISPLAY INCLUDING THE SAME

(71) Applicant: SAMSUNG DISPLAY CO., LTD., Yongin-City (KR)

(72) Inventors: Hyo Sung HONG, Gyeonggi-do (KR); Ji Hoon Kim, Gyeonggi-do (KR); Teck Soo Kim, Gyeonggi-do (KR); Kwang Hyun Kim, Gyeonggi-do (KR); Sang Jae Kim, Gyeonggi-do (KR); Ji Hye Kim, Gyeonggi-do (KR); Gwan Young Na, Gyeonggi-do (KR); Hyoung Joo Lee, Seoul (KR); Seon Ah Cho, Busan (KR)

(21) Appl. No.: 14/751,931

(22) Filed: Jun. 26, 2015

(30) Foreign Application Priority Data
Dec. 9, 2014 (KR) 10-2014-0176012

(51) Int. Cl. G02F 1/13363; G02F 1/1335; G02F 1/1368

(52) U.S. Cl. CPC G02F 1/13363; G02F 1/1368; G02F 1/133514; G02F 1/133512; G02F 1/133528; G02F 2413/12

(57) ABSTRACT

Provided is a liquid crystal display panel including a thin-film transistor (TFT) array substrate and a first phase difference film. A liquid crystal layer is disposed between the TFT array substrate and the first phase difference film. A second phase difference film is disposed on the first phase difference film. A phase retardation value of the first phase difference film in a thickness direction is in a range of from about 100 nm to about 300 nm.

### CROSS-REFERENCE TO RELATED APPLICATION

This application claims priority under 35 U.S.C. §119 to Korean Patent Application No. 10-2014-0176012 flied on Dec. 9, 2014 in the Korean Intellectual Property Office, the disclosure of which is incorporated by reference herein in its entirety.

1. Technical Field

Exemplary embodiments of the present invention relate to a liquid crystal display (LCD) panel and an LCD including the same.

2. Discussion of Related Art

A liquid crystal display (LCD) may include a thin-film transistor (TFT), a pixel electrode, a common electrode, and liquid crystals disposed between two substrates.

The liquid crystals in a liquid crystal layer may be operated in a vertical alignment (VA) mode by an application of an electric field formed between the pixel electrode and the common electrode. For example, when an electric field is not formed between the pixel electrode and the common electrode, an LCD panel may display a black image. When the electric field is formed between the pixel electrode and the common electrode, the LCD panel may display images of various gray levels.

When an electric field is formed between the pixel electrode and the common electrode, the liquid crystals in the liquid crystal layer may be arranged at an angle less than 90 degrees with respect to the pixel electrode or the common electrode, thereby producing a gradually brighter image. If the liquid crystals are arranged in a vertical direction, a darker black image with low luminance may be displayed on the LCD panel when light is transmitted onto the front of the LCD panel. However, the luminance of the black image may be higher when light is transmitted onto a side of the LCD panel than when light is transmitted onto the front of the LCD panel. This may occur because light transmitted to a side of the LCD panel obliquely passes through the LCD panel and is thus more phase-delayed by the liquid crystals compared with light transmitted to the front of the LCD panel. Since light transmitted to the side of the LCD panel may be scattered as it passes through the TFT and a color filter, the polarization state of the light may be changed, thus causing leakage of light.

In this regard, research is being actively conducted to minimize the leakage of light from an LCD panel.

### SUMMARY OF THE INVENTION

Exemplary embodiments of the present invention provide a liquid crystal display (LCD) panel having a relatively wide lateral viewing angle and increased visibility by optimization of an optical path of light and an LCD including the LCD panel.

Exemplary embodiments of the present invention provide a relatively thin LCD panel which may reduce manufacturing costs and an LCD including the LCD panel.

However, exemplary embodiments of the present invention are not limited thereto or thereby.

According to an exemplary embodiment of the present invention, a liquid crystal display (LCD) panel includes a thin-film transistor (TFT) array substrate and a first phase difference film. A liquid crystal layer is disposed between the TFT array substrate and the first phase difference film. A second phase difference film is disposed on the first phase difference film. A phase retardation value of the first phase difference film in a thickness direction is in a range of from about 100 nm to about 300 nm.

According to an exemplary embodiment of the present invention, a liquid crystal display (LCD) includes a light source, and a liquid crystal display panel which is configured to receive light emitted from the light source. The liquid crystal display panel includes a TFT array substrate and a first phase difference film. A liquid crystal layer is disposed between the TFT array substrate and the first phase difference film. A second phase difference film is disposed on the first phase difference film. A phase retardation value of the first phase difference film in a thickness direction is in a range of from about 100 nm to about 300 nm.

### BRIEF DESCRIPTION OF THE DRAWINGS

The above and other aspects and features of the present invention will become more apparent by describing in detail exemplary embodiments thereof with reference to the accompanying drawings, in which:

FIG. 1 is a schematic cross-sectional view of a liquid crystal display (LCD) panel according to an exemplary embodiment of the present invention;

FIG. 2 is a cross-sectional view of the LCD panel illustrated in FIG. 1;

FIG. 3 is a cross-sectional view of an LCD panel according to an exemplary embodiment of the present invention;

FIG. 4 is a cross-sectional view of an LCD panel according to an exemplary embodiment of the present invention;

FIG. 5 is a schematic cross-sectional view of an LCD according to an exemplary embodiment of the present invention;

FIG. 6 is a schematic cross-sectional view of an LCD according to an exemplary embodiment of the present invention;

FIG. 7 is a schematic cross-sectional view of an LCD according to an exemplary embodiment of the present invention; and

FIG. 8 is a schematic cross-sectional view of an LCD according to an exemplary embodiment of the present invention.

### DETAILED DESCRIPTION OF THE INVENTION

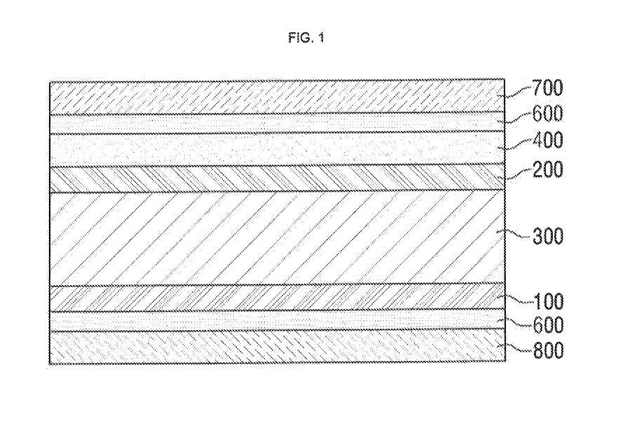

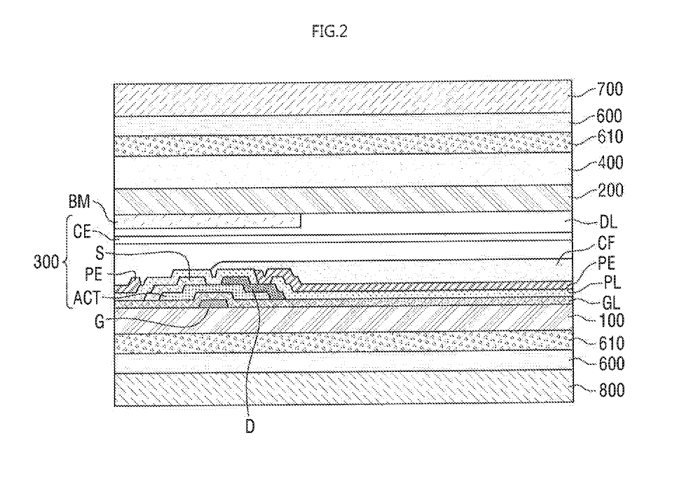

FIG. 1 is a schematic cross-sectional view of a liquid crystal display (LCD) panel according to an exemplary embodiment of the present invention. FIG. 2 is a cross-sectional view of the LCD panel illustrated in FIG. 1.

Referring to FIGS. 1 and 2, the LCD panel according to the an exemplary embodiment of the present invention may include a thin-film transistor (TFT) array substrate 100 and a first phase difference film 200, which may face each other, a liquid crystal layer 300 which is disposed between the TFT array substrate 100 and the first phase difference film 200, and a second phase difference film 400 which is disposed on the first phase difference film 200. A phase retardation value Rₜₕ of the first phase difference film 200 in a thickness direction may be in a range of from about 100 nm to about 300 nm.

According to an exemplary embodiment of the present invention, the TFT array substrate 100 and the first phase difference film 200 having a specific phase retardation value may face each other, and the liquid crystal layer 300 may be disposed between the TFT array substrate 100 and the first phase difference film 200. Therefore, the first phase difference film 200 may cap and protect the liquid crystal layer 300 and internal elements of the liquid crystal layer 300 while increasing a viewing angle due to the phase retardation value Rₜₕ of the first phase difference film 200. Accordingly, a thickness of the LCD panel may be reduced and a wider viewing angle may be achieved for the LCD panel. By optically designing the phase difference of the first phase difference film 200, as lateral viewing angle for the LCD panel may be increased, and visibility can be increased.

According to an exemplary embodiment of the present invention, an additional substrate might not be disposed facing the TFT array substrate 100 to create a specific phase difference. The first phase difference film 200 may create a specific phase difference and may cap the TFT array substrate 100. Therefore, the LCD panel may be a relatively thin LCD panel. This may reduce manufacturing costs, resulting in a reduction in the unit price of a product.

The TFT array substrate 100 may include a TFT and a pixel electrode PE disposed on the TFT.

A gate electrode G may be disposed on the TFT array substrate 100. A gate insulating layer GL may be disposed on the gate electrode G, and the TFT array substrate 100. A semiconductor layer ACT may be disposed on at least a portion of the gate insulating layer GL. For example, the semiconductor layer ACT may be disposed on a portion of the gate insulating layer BL which overlaps the gate electrode G. A source electrode S and a drain electrode D may be disposed on the semiconductor layer ACT. The source electrode S and a drain electrode D may be disposed separately from each other. A passivation layer PL may be disposed on the gate insulating layer GL, the source electrode 5, the semiconductor layer ACT and the drain electrode D. The pixel electrode PE may be disposed on the passivation layer PL and may be electrically connected to the drain electrode D via a contact hole which at least partially exposes the drain electrode D. According to exemplary embodiments of the present invention, the gate electrode G, the gate insulating layer GL, the semiconductor layer ACT, the source electrode S, the drain electrode D and the passivation layer PL may be disposed on the TFT array substrate 100 to display images, and may be collectively referred to as a TFT or as the TFT array substrate 100.

A color filter CF may be disposed on the pixel electrode PE. According to an exemplary embodiment of the present invention, the color filter CF may be disposed directly on the pixel electrode PE, which may be disposed on the TFT array substrate 100. Therefore, an error range between the color filter CF and the pixel electrode PE may be reduced or eliminated, thereby reducing or eliminating the leakage of light.

The color filter CF may be a red, green, or blue color filter. The color filter CF may be a color filter known to those of ordinary skill in the art, and thus a more detailed description thereof may be omitted.

The TFT array substrate 100 may include an insulating material. For example, the TFT array substrate 100 may include a relatively hard material such as glass. The TFT array substrate 100 may include a plastic resin such as polycarbonate resin. The TFT array substrate 100 may include a flexible material such as polyimide resin. That is, a material included in the TFT array substrate 100 may be selected as desired.

The phase retardation value Rₜₕ in the thickness direction and an in-plane phase retardation value Re, which will be described in more detail below, may be defined by Equations (1) and (2) below:

Re=(nz−ny)×d (1)

Rₜₕ=((nx+ny)/2−nz)×d (2)

where nx is a refractive index in the direction of an in-plane slow axis, ny is a refractive index in the direction of an in-plane fast axis, nz defines a refractive index in the thickness direction, and d is a thickness of a phase difference film.

The first phase difference film 200 may satisfy a relationship of nx=ny>nz. A phase difference film satisfying the above relationship may be referred to as a negative C-plate. The phase retardation value Rₜₕ of the first phase difference film 200 in the thickness direction may range from about 100 nm to about 300 nm, for example, from about 190 nm to about 210 nm.

The thickness of the first phase difference film 200 may range from about 1 nm to about 100 nm, for example, from about 1 nm to about 20 nm. When satisfying the above range, the first phase difference film 200 may be included in a relatively thin display panel and the first phase difference film 200 may satisfy the above phase retardation value. The first phase difference film 200 facing the ITT array substrate 100 may protect the internal elements of the LCD panel.

The first phase difference film 200 may include a polyimide polymer and/or a polyamide polymer. The first phase difference film 200 may be formed by mixing the polyimide polymer or the polyamide polymer with a solvent. Examples of the solvent may include a haloalkane compound, an aromatic compound, and an ether compound. For example, tetrahydrofuran (TEM), acetone, methyl ethyl keton, 1-methyl-2-pyrrolidone (NMP), dimethylsulfoxide (DMSO), and any mixture thereof may be used. These materials may be used alone or in a combination of two or more of the materials.

The second phase difference film 400 may satisfy a relationship of nx>ny=nz. A phase difference film satisfying the above relationship may be referred to as a positive A-plate. The in-plane phase retardation value Re of the second phase difference film 400 may range from about 120 mn to about 140 mn. The phase retardation value Rₜₕ of the second phase difference film 400 in the thickness direction may range from about −10 nm to about 10 nm, preferably, substantially 0 nm. The optical design of the second phase difference film 400 and the first phase difference film 200 may increase the lateral viewing angle and increase visibility. That is, the leakage of light due to the scattering of light in the color filter CF and a black matrix BM may be reduced or eliminated.

The second phase difference film 400 may include tri-acetyl cellulose (TAC), cyclic olefin polymer (COP)-based resin, and/or acrylic polymer resin.

The LCD panel may include the black matrix BM disposed on the first phase difference film 200. The black matrix BM may face the TFT array substrate 100. The black matrix BM may be disposed between adjacent color filters CF to prevent color mixing between pixels. The black matrix BM may be disposed over the TFT. The black matrix BM may be a black matrix known to those of ordinary skill in the art, and thus a more detailed description may be omitted.

A planarization layer DL may be disposed under the black matrix BM, and a common electrode CE may cover a lower surface of the planarization layer DL. The common electrode CE may include a transparent conductive material and may receive a common voltage. The planarization layer DL may be omitted.

A sealant may be disposed between the TFT array substrate 100 and the first phase difference film 200 to protect internal elements and prevent liquid crystals of the liquid crystal layer 300 from flowing out. The sealant may be disposed along edges of the TFT array substrate 100 and may include a UV curable resin, or a thermosetting resin.

The liquid crystal layer 300 may be operated in a vertical alignment (VA) mode. For example, when an electric field is not formed between the pixel electrode PE and the common electrode CE, the LCD panel may display a black image. When the electric field is formed between the pixel electrode PE and the common electrode CE, the LCD panel may display images of various gray levels. The VA-mode liquid crystal layer 300 may increase the viewing angle of the LCD panel.

When an electric field is not formed between the pixel electrode PE and the common electrode CE, the liquid crystals of the liquid crystal layer 300 may be arranged in a direction perpendicular to a surface of the TFT array substrate 100. When the electric field is formed between the pixel electrode PE and the common electrode CE, the liquid crystals of the liquid crystal layer 300 may be arranged at an angle with respect to the surface of the TFT array substrate 100. As the intensity of the electric field increases, the angle of the liquid crystals may increase. Eventually, the liquid crystals may be arranged in a direction horizontal with respect to the surface of the TFT array substrate 100.

The LCD panel may include a lower polarizing plate 610 disposed under the TFT array substrate 100 and an upper polarizing plate 610 disposed on the second phase difference film 400.

Each of the upper polarizing plate 610 and the lower polarizing plate 610 may include a polarizer 600. The polarizer 600 may be a polyvinyl alcohol (PVA) film dyed with iodine or dichromatic dye. The polarizer 600 may be prepared by dying, crosslinking, swelling and drawing the PVA film, The polarizer 600 and the process of preparing the polarizer 600 may be a polarizer and polarizer preparation process that is known to those of ordinary skill in the art, and thus a more detailed description thereof may be omitted.

The upper polarizing plate 610 and/or the lower polarizing plate 610 may be attached to the TFT array substrate 100 and/or the second phase difference film 400 using an adhesive, and a protective film may be attached to a surface of the polarizing plate 610 which is attached to the TFT array substrate 100 and/or the second phase difference film 400. However, exemplary embodiments of the present invention are not limited thereto, and the protective film may be omitted.

The lower polarizing plate 610 may include the polarizer 600 and a polarizer protecting film 800 formed on at least one surface of the polarizer 600. The polarizer protecting film 800 of the lower polarizing plate 610 may have a phase retardation value of substantially zero.

Although not illustrated in the drawings, each of the upper polarizing plate 610 and the lower polarizing plate 610 may include a wire grid polarizer.

Transmission axes of the upper polarizing plate 610 and the lower polarizing plate 610 may be orthogonal or parallel to each other. The upper polarizing plate 610 and/or the lower polarizing plate 610 may be omitted.

A total phase retardation value of the LCD panel according to an exemplary embodiment of the present invention may include the in-plane phase difference value Re in a range of from about 40 nm to about 65 nm and the phase difference value Rₜₕ in the thickness direction may be in a range of from about 200 nm to about 300 nm. When the VA-mode liquid crystal layer 300 has the above Re and Rₜₕ ranges, the display panel have a relatively wide viewing angle.

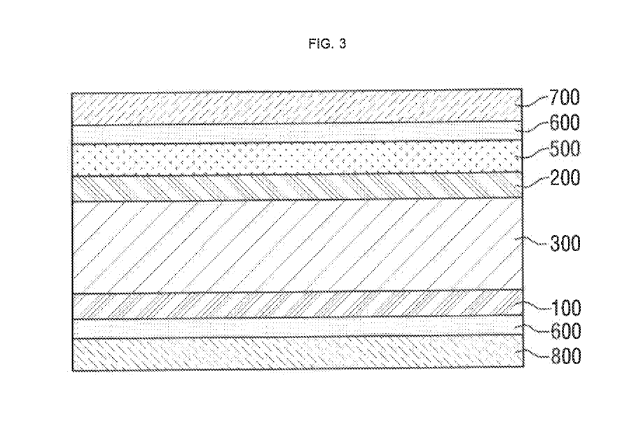

FIG. 3 is a cross-sectional view of an LCD panel according to an exemplary embodiment of the present invention.

Referring to FIG. 3, a second phase difference film 500 may include a biaxial film and may satisfy a relationship of nx>ny>nz or a relation of nx>nz>ny. A phase difference film satisfying the above relationship may be referred to as a B-plate.

The in-plane phase retardation value Re of the second phase difference film 500 may range from about 120 nm to about 150 nm. The phase retardation value Rₜₕ of the second phase difference film 500 in a thickness direction may range from about 60 nm to about 80 nm. The optical design of the second phase difference film 500 and a first phase difference film 200 may increase lateral viewing angle and increase visibility. The leakage of light due to the scattering of light in the color filter CF and the black matrix BM may be reduced or eliminated.

The second phase difference film 500 may include at least one of, but is not limited to, TAC, COP-based resin, and acrylic polymer resin.

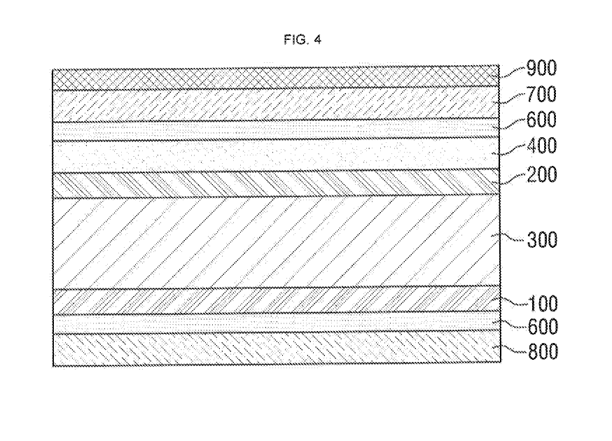

FIG. 4 is a cross-sectional view of an LCD panel according to an exemplary embodiment of the present invention.

Referring to FIG. 4, the LCD panel may include an optical functional layer 900 disposed on the polarizer protecting film 700 of an upper polarizing plate. The optical functional layer 900 may include various optical functional layers such as a reflection preventing layer, a fingerprint preventing layer, and/or a refraction preventing layer. The optical functional layer 900 may be a desired optical functional layer, which may be selected as desired by those of ordinary skill in the art.

Other elements of the LCD panel illustrated in FIG. 4 may be substantially identical to those of the LCD panel according to the above-described exemplary embodiments of the present invention, and repetitious descriptions may be omitted.

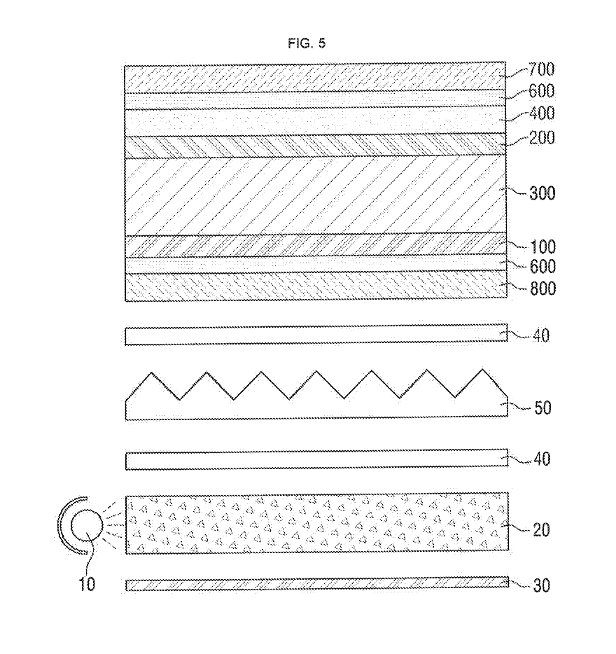

FIG. 5 is a schematic cross-sectional view of an LCD according to an exemplary embodiment of the present invention.

Referring to FIG. 5, the LCD may include a light source 10 and an LCD panel for displaying an image when receiving light from the light source 10. The LCD panel may include the TFT array substrate 100 and the first phase difference film 200 which may face each other, the liquid crystal layer 300 which may be disposed between the TFT array substrate 100 and the first phase difference film 200, and the second phase difference film 400 which may be disposed on the first phase difference film 200. The phase retardation value Rₜₕ of the first phase difference film 200 in a thickness direction may be in a range of from about 100 nm to about 300 mn.

The in-plane phase retardation value Re of the second phase difference film 400 may range from about 120 nm to about 140 nm, and the phase delay value Rₜₕ of the second phase difference film 400 in the thickness direction may range from about −10 mn to about 10 nm.

The second phase difference film 400 disposed on the LCD panel may include a biaxial film. The in-plane phase retardation value Re of the second phase difference film 400 including the biaxial film may range from about 120 nm to about 150 nm, and the phase retardation value Rₜₕ of the second phase difference film 400 including the biaxial film in the thickness direction may range from about 60 nm to about 80 nm.

Other elements of the LCD panel illustrated in FIG. 5 may be substantially identical to those of the LCD panel described above, and repetitious descriptions may be omitted.

The LCD of FIG. 5 may include an edge-type backlight unit having a light source disposed on a side of the LCD panel. Referring to FIG. 5, the LCD may include the light source 10, the LCD panel described above, and one or more optical plates such as a light guide plate (LGP) 20, a reflection sheet 30, a diffusion sheet 40 and a prism sheet 50. The light source 10 may be disposed on a side of the LGP 20. The LGP 20 may guide light emitted toward a side surface of the LGP 20 from the light source 10 and may guide the light toward the LCD panel. Light propagating downward from the LGP 20 may be reflected by the reflection sheet 30 to travel upward.

The LGP 20 may change the path of light emitted from the light source 10 toward the liquid crystal layer 300 of the LCD panel. The LGP 20 may include an incident surface upon which light emitted from the light source 10 is transmitted and an exit surface which faces the liquid crystal layer 300. The LGP 20 may include, but is not limited to, a material having light-transmitting properties such as polymethyl methacrylate (PMMA) or a material having a constant refractive index such as polycarbonate (PC).

Light emitted onto a side surface or both side surfaces of the LGP 20 including the above materials may have an angle smaller than a critical angle of the LGP 20. Thus, light may be transmitted to the LGP 20. When light is transmitted onto upper and/or lower surfaces of the LGP 20, an incidence angle of the light may be greater than the critical angle. Thus, light may be evenly transmitted within the LGP 20 without exiting from the LGP 20.

Scattering patterns (not shown) may be formed on the upper and/or lower surfaces of the LGP 20. For example, the scattering patterns may be formed on the lower surface of the LGP 20 which faces the upper surface of the LGP 20, and light guided by the LGP 20 may travel upward. The scattering patterns may be printed on a surface of the LGP 20 using ink, and light reaching the scattering patterns within the LGP 20 may exit upward from the LGP 20. However, exemplary embodiments of the present invention are not limited thereto or thereby, and the scattering patterns may take various forms such as micro grooves or micro protrusions on the LGP 20.

The reflection sheet 30 may be disposed under the LGP 20. The reflection sheet 30 may reflect light output from the lower surface of the LGP 20 back to the LGP 20. The reflection sheet 30 may include a film including a metal material that reflects light, but exemplary embodiments of the present invention are not limited thereto or thereby. The reflection sheet 30 may be a reflection sheet that is known to those of ordinary skill in the art, and thus a more detailed description may be omitted.

The light source 10 may include a white light-emitting diode (LED) which emits white light or may include a plurality of LEDs which emit red (R) light, green (G) light and/or blue (B) light. When the light source 10 includes a plurality of LEDs which emit red light, green light and/or blue light, the LEDs may be turned on simultaneously to produce white light through color mixing.

The diffusion sheet 40 may diffuse a portion of light emitted from the light source 10 and send the diffused portion of light to the LCD panel and reflect the other portion of the light downward. In an exemplary embodiment of the present invention, the diffusion sheet 40 may include, but is not limited to, polymethyl methacrylate (PMMA), polystyrene (PS), polycarbonate (PC), cyclo-olefin copolymer (COC), polyethylene terephthalate (PET), polybutylene terephthalate (PBT), or a plastic alloy.

The diffusion sheet 40 may be disposed on the upper surface of the LGP 20 and on the prism sheet 50, as illustrated in FIG. 5, for example. However, exemplary embodiments of the present invention are not limited thereto or thereby. Any one of the diffusion sheets 40 may be omitted, or two or more diffusion sheets 40 may be disposed on each other at any one location. The number and placement of the diffusion sheets 40 may be changed as desired.

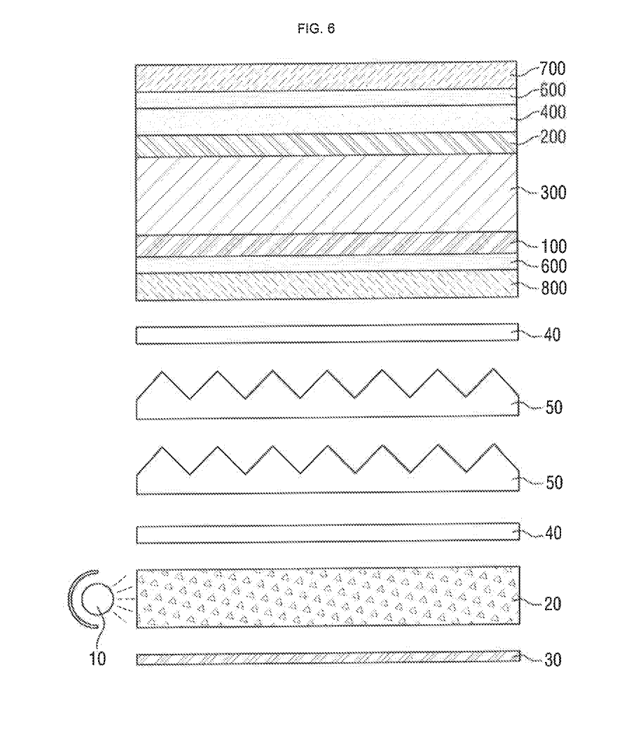

The prism sheet 50 may focus light transmitted from the diffusion sheet 40 or the LGP 20 in a direction perpendicular to a plane of the LCD panel. The prism sheet 50 may be disposed on the upper surface of the LGP 20. Two or more prism sheets 50 may be disposed on each other, as illustrated in FIG. 6, for example. The number and placement of the prism sheets 50 may be changed as desired.

The LCD panel may include a micro-lens array film and/or a lenticular lens film. The micro-lens array film and the lenticular lens film may be films that are known to those of ordinary skill in the art, and thus a more detailed description may be omitted.

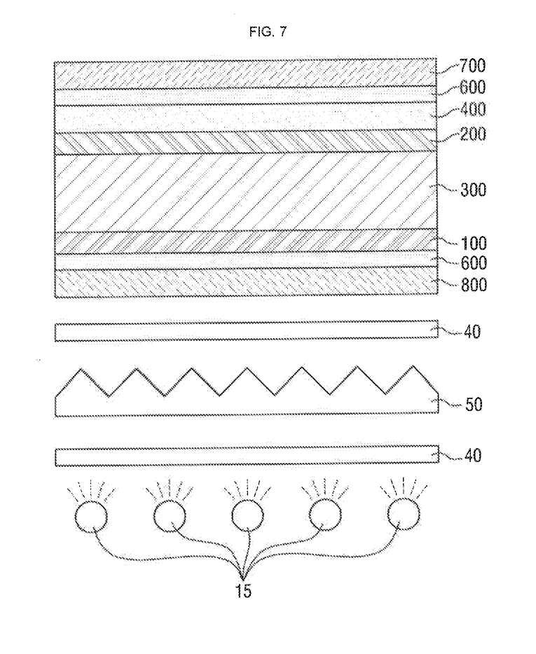

FIG. 7 is a schematic cross-sectional view of an LCD according to an exemplary embodiment of the present invention.

The LCD of FIG. 7 may include a direct-type backlight unit.

The LCD may include a plurality of light sources 15 disposed under the LCD panel. Light emitted from the light sources 15 may pass through one or more optical plates such as the diffusion sheet 40 and/or the prism sheet 50 to reach the LCD panel disposed above the light sources 15. The LCD of FIG. 7 may include the direct-type backlight unit and the LGP 20 may be omitted.

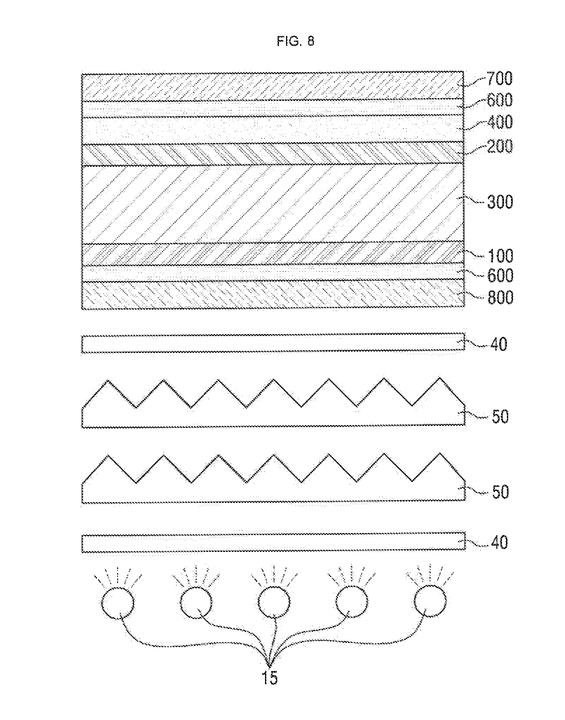

FIG. 8 is a schematic cross-sectional view of an LCD according to an exemplary embodiment of the present invention. Referring to FIG. 8, two or more prism sheets 50 may be disposed on each other at one location. To reduce a moire phenomenon caused by regularity between the color filter CF disposed on an LCD panel and prism patterns formed on the prism sheet 50, an irregularity may be formed on the prism patterns of the prism sheet 50.

Although not illustrated in the drawing, the LCD may include a bottom chassis, a middle frame, and/or a top chassis. The optical plate may be disposed between the bottom chassis and the LCD panel, and the LCD panel may be disposed on the middle frame. The top chassis may be coupled to the bottom chassis and may fix the middle frame in a desired position, thereby fixing elements of the LCD panel and the LCD in desired positions.

Exemplary embodiments of the present invention may provide an LCD panel having an increased lateral viewing angle and increased visibility by optimization of an optical path of light and an LCD including the LCD panel.

Exemplary embodiments of the present invention may provide a thinner LCD panel which can reduce manufacturing costs and an LCD including the LCD panel.

While the invention has been particularly shown and described with reference to exemplary embodiments thereof, it will be understood by those of ordinary skill in the art that various changes in provide form and detail may be made therein without departing from the spirit and scope of the present invention.

What is claimed is:

1. A liquid crystal display (LCD) panel comprising:
a thin-film transistor (TFT) array substrate;
a first phase difference film;
a liquid crystal layer disposed between the TFT array substrate and the first phase difference film; and
a second phase difference film disposed on the first phase difference film,
wherein a phase retardation value of the first phase difference film in a thickness direction is in a range of from about 100 nm to about 300 nm.

2. The liquid crystal display panel of claim 1, wherein the liquid crystal layer has a vertical alignment (VA) mode.

3. The liquid crystal display panel of claim 1, further comprising a color filter, wherein the TFT array substrate comprises a TFT and a pixel electrode disposed on the TFT, and wherein the color filter is disposed on the pixel electrode.

4. The liquid crystal display panel of claim 1, further comprising a black matrix disposed on the first phase difference film, wherein the black matrix faces the TFT array substrate.

5. The liquid crystal display panel of claim 1, wherein an in-plane phase retardation value of the second phase difference film is in a range of from about 120 nm to about 140 nm.

6. The liquid crystal display panel of claim 1, wherein the second phase difference film comprises a biaxial film.

7. The liquid crystal display panel of claim 6, wherein an in-plane phase retardation value of the second phase difference film is in a range of from about 120 nm to about 150 nm, and wherein a phase retardation value of the second phase difference film in the thickness direction is in a range of from about 60 nm to about 80 mn.

8. The liquid crystal display panel of claim 1, further comprising a lower polarizing plate disposed under the TFT array substrate and an upper polarizing plate disposed on the second phase difference film.

9. The liquid crystal display panel of claim 8, wherein the lower polarizing plate comprises a polarizer and a polarizing protecting film disposed on at least one surface of the polarizer, and wherein the polarizer protecting film has a phase retardation value of substantially zero.

10. The liquid crystal display panel of claim 1, wherein the first phase difference film has a thickness of from about 1 μm to about 100 μm.

11. The liquid crystal display panel of claim 1, wherein the first phase difference film comprises a polyimide polymer or a polyamide polymer.

12. The liquid crystal display panel of claim 1, wherein the second phase difference film comprises at least one of tri-acetyl cellulose (TAC), cyclic olefin polymer (COP)-based resin, and acrylic polymer resin.

13. The liquid crystal display panel of claim 1, wherein a total phase retardation value of the LCD panel comprises an in-plane phase retardation in a range of from about 40 nm to about 65 nm and a phase retardation value in the thickness direction in a range of from about 200 nm to about 300 mn.

14. A liquid crystal display comprising:
a light source; and
a liquid crystal display panel configured to receive light emitted from the light source,
wherein the liquid crystal display panel comprises:
a TFT array substrate;
a first phase difference film;
liquid crystal layer disposed between the TFT array substrate and the first phase difference film; and
a second phase difference film disposed on the first phase difference film,
wherein a phase retardation value of the first phase difference film in a thickness direction is in a range of from about 100 nm to about 300 mn.

15. The liquid crystal display of claim 14, further comprising an optical plate disposed between the light source and the liquid crystal display panel, wherein the optical plate comprises at least one of a prism sheet, a diffusion sheet, a light guide plate (LGP), and a reflection sheet.

16. The liquid crystal display of claim 14, wherein the liquid crystal layer has a vertical alignment (VA) mode.

17. The liquid crystal display of claim 14, wherein an in-plane phase retardation value of the second phase difference film is in a range of from about 120 nm to about 140 mn.

18. The liquid crystal display of claim 14, wherein the second phase difference film comprises a biaxial film.

19. The liquid crystal display of claim 18, wherein an in-plane phase retardation value of the second phase difference film is in a range of from about 120 nm to about 150 nm, and wherein a phase retardation value of the second phase difference film in the thickness direction is in a range of from about 60 nm to about 80 nm.

20. The liquid crystal display of claim 14, wherein the liquid crystal display panel further comprises a color filter, wherein the TFT array substrate comprises a TFT and a pixel electrode disposed on the TFT, and wherein the color filter is disposed on the pixel electrode.
